(19) United States
(12) Patent Application Publication
(10) Pub. No.: US 2023/0237852 A1
(43) Pub. Date: Jul. 27, 2023

(54) Method and Apparatus for Charging Parking Fee

(71) Applicants: Hyundai Motor Company, Seoul (KR); Kia Corporation, Seoul (KR)

(72) Inventor: Jang Shin Kim, Gunpo-si (KR)

(21) Appl. No.: 17/984,539

(22) Filed: Nov. 10, 2022

(30) Foreign Application Priority Data
Jan. 21, 2022 (KR) 10-2022-0009080

(51) Int. Cl. G07B 15/02; G08G 1/14

(52) U.S. Cl. CPC G07B 15/02; G08G 1/148

(57) ABSTRACT

An embodiment apparatus for charging a parking fee includes a reservation information communications device that receives reservation information and transmits the reservation information to a communication terminal, a reserved vehicle recognition device that recognizes a vehicle number of a reserved vehicle and whether the reserved vehicle enters or exits the parking lot by using a camera, a traffic flow determination device that divides an area of each floor of the parking lot into plural areas based on a unit area, receives locations of vehicles within the parking lot, and calculates a density of the vehicles within the parking lot, a driving route generation device that generates an optimal route, a route guidance device that provides the user with the optimal route, and an off-route charging device that charges the user for moving off-route when the reserved vehicle does not move along the optimal route.

### CROSS-REFERENCE TO RELATED APPLICATIONS

This application is based on, and claims priority from, Korean Patent Application Number 10-2022-0009080, filed Jan. 21, 2022, the disclosure of which is incorporated by reference herein its entirety.

### TECHNICAL FIELD

The present disclosure relates to an apparatus and a method for charging a parking fee.

### BACKGROUND

Contents described in this section merely provide background information of embodiments of the present disclosure and do not constitute a conventional technology.

There is a technology by which a parking space of a parking lot can be reserved online. A user may reserve and schedule a parking lot, a floor of the parking lot, a parking space, a date and time, etc. by using the Internet, an application, etc.

A method of paying parking rates includes an electronic payment method. If the settlement of the parking rates is an electronic payment method, a user of a parking lot may pay the parking rates from a pre-registered credit card and/or bank account without the need to use cash and/or a credit card at a site. Such an electronic payment method may be combined with the aforementioned parking reservation technology. Through the combined technology, a user may conveniently use a parking lot.

The number of vehicles using a parking lot is different depending on a date and/or a time. If the area of a parking lot is narrow and the number of vehicles using the parking lot is many, if vehicles randomly drive, there are problems in that traffic congestion and a traffic accident occur.

Furthermore, in a conventional method for the electronic payment of parking rates, sanctions against a vehicle driving on a given moving route are impossible because a user is charged for only a violation of traffic and/or a violation of reservation. There is a problem in that a traffic flow within a parking lot is congested due to vehicles that randomly drive.

### SUMMARY

An embodiment of the present disclosure provides an apparatus for charging a parking fee comprising a reservation information communications unit receiving, from a communication device of a parking lot, reservation information comprising one or more of the parking lot reserved by a user, a floor of the parking lot, a parking-reserved space, a user grade, a vehicle type, a vehicle number, a date, and a parking lot use time and transmitting the reservation information to a communication terminal of the user, a reserved vehicle recognition unit recognizing a vehicle number of a reserved vehicle and recognizing whether the reserved vehicle enters the parking lot or exits from the parking lot by using a camera, a traffic flow determination unit dividing an area of each floor of the parking lot into plural areas based on a unit area, receiving locations of vehicles within the parking lot, and calculating density within the parking lot based on the number of vehicles within each unit area, a driving route generation unit generating an optimal route comprising a unit area whose density is determined to be relatively low based on the calculated density, a route guidance unit providing the user with a route generated by the driving route generation unit, and an off-route charging unit charging the user for moving off-route if the reserved vehicle does not move along the route provided by the route guidance unit.

Another embodiment of the present disclosure provides a method of charging parking fee comprising a process of receiving, from a communication device of a parking lot, reservation information comprising one or more of the parking lot reserved by a user, a floor of the parking lot, a parking-reserved space, a user grade, a vehicle type, a vehicle number, a date, and a parking lot use time and transmitting the reservation information to a communication terminal of the user, a process of recognizing a vehicle number of a reserved vehicle and recognizing whether the reserved vehicle enters the parking lot or exits from the parking lot by using a camera, a process of dividing an area of each floor of the parking lot into plural areas based on a unit area, receiving locations of vehicles within the parking lot, and calculating density within the parking lot based on the number of vehicles within each unit area, a process of generating an optimal route comprising a unit area whose density is determined to be relatively low based on the calculated density, a process of providing the user with a route generated in the generating process, and a process of charging the user for moving off-route if the reserved vehicle does not move along the provided route.

### BRIEF DESCRIPTION OF THE DRAWINGS

FIG. 1 is a block diagram of an apparatus for charging a parking fee according to one exemplary embodiment of the present disclosure.

FIG. 2 is a flowchart of charging, by the apparatus for charging a parking fee according to one exemplary embodiment of the present disclosure, a reserved vehicle that parks.

FIG. 3 is a flowchart of charging, by the apparatus for charging a parking fee according to one exemplary embodiment of the present disclosure, a reserved vehicle that exits from a parking lot.

FIG. 4 is one exemplary diagram of parking information provided to a user by the apparatus for charging a parking fee according to an embodiment of the present disclosure.

FIG. 5 is one exemplary diagram for charging a user for moving off-route when a reserved vehicle deviates from a provided route by the apparatus for charging a parking fee according to an embodiment of the present disclosure.

FIG. 6 is one exemplary diagram for charging a user for a violation of a reservation when a reserved vehicle parks in a parking space not a parking-reserved space according to an embodiment of the present disclosure.

The following reference identifiers may be used in connection with the accompanying drawings to describe exemplary embodiments of the present disclosure.
100: Reservation information communications unit
no: Reserved vehicle recognition unit
120: Traffic flow determination unit
130: Driving route generation unit
140: Route guidance unit
150: Charging unit
152: Off-route charging unit
154: Reservation violation charging unit
156: Parking use charging unit
160: Autonomous driving unit
170: Parking information provision unit

### DETAILED DESCRIPTION OF ILLUSTRATIVE EMBODIMENTS

An apparatus for charging a parking fee according to an embodiment may provide a user with a route to a parking-reserved space based on the density of a parking lot.

An apparatus for charging a parking fee according to an embodiment may charge a user for a reserved vehicle that has deviated from a provided moving route.

The issues solvable by embodiments of the present disclosure are not limited to the aforementioned issues, and the other issues not described above may be evidently understood from the following description by those skilled in the art.

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

In describing the components of the embodiments, alphanumeric codes may be used such as first, second, i), ii), a), b), etc., solely for the purpose of differentiating one component from others but not to imply or suggest the substances, the order, or the sequence of the components. Throughout this specification, when parts “include” or “comprise” a component, they are meant to further include other components, not to exclude thereof unless there is a particular description contrary thereto.

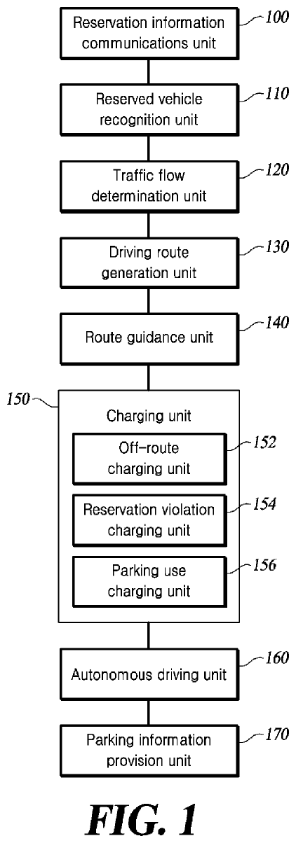

FIG. 1 is a block diagram of an apparatus for charging a parking fee according to one exemplary embodiment of the present disclosure.

Referring to FIG. 1, the apparatus for charging a parking fee may include a reservation information communications unit 100, a reserved vehicle recognition unit no, a traffic flow determination unit 120, a driving route generation unit 130, a route guidance unit 140, a charging unit 150, an autonomous driving unit 160, and a parking information provision unit 170 in whole or in part.

The reservation information communications unit 100 receives reservation information from a communication device of a parking lot. In this case, the reservation information includes one or more of a parking lot reserved by a user, a floor of the parking lot, a parking-reserved space, a user grade, a vehicle type, a vehicle number, a date, and a parking lot use time. In this case, the user grade is an index by which users are classified based on a given criterion depending on frequency of a parking lot being used. For example, a user who uses a parking lot five times or more for a preset period may be classified as a VIP, and a user who uses a parking lot less than one time for a preset period may be classified as a common user. In a process of reserving a parking space, a discount for priority and parking rates may be provided to the selection of a parking lot and a parking space based on a user grade.

The communication device of the parking lot is a device that receives reservation information based on a parking lot reservation application, etc. The reservation information communications unit 100 transmits, to a communication terminal of a user, received reservation information and charging guidance according to the user of a parking lot. Charging is described later.

The reserved vehicle recognition unit no recognizes a vehicle within a preset distance from the entrance of a parking lot by using a camera. When a vehicle enters a parking lot or exits from the parking lot, the reserved vehicle recognition unit no recognizes a vehicle number by using a camera.

If the reserved vehicle recognition unit no does not recognize a reserved vehicle for a preset time from a scheduled time based on reservation information, the reservation information communications unit 100 transmits, to a communication terminal of a user, a message that inquires about a reservation change. When the reservation information communications unit 100 receives a message indicating that a reservation is changed, the reserved vehicle recognition unit no recognizes a reserved vehicle based on changed reservation information.

The traffic flow determination unit 120 receives locations of all vehicles within a parking lot. In the case of an already parked vehicle, the traffic flow determination unit 120 receives the final location where the vehicle has already parked. The traffic flow determination unit 120 calculates density based on the received location. The density means the number of vehicles present for each of unit areas obtained by dividing the area of each floor of a parking lot into given unit areas. The size of the unit area may be randomly set. The traffic flow determination unit 120 determines that the density is low or high based on a density degree. The meaning that the density is low means that a traffic flow in a corresponding unit area is smooth. The meaning that the density is high means that a traffic flow in a corresponding unit area is congested. For example, if the area of a lower ground floor one of a parking lot is 500 m² and the area of the lower ground floor one is divided into unit areas each being 100 m², the areas may be denoted as a first area, a second area, a third area, a fourth area, and a fifth area. If the number of vehicles within the first area is 10, the traffic flow determination unit 120 may determine that the density of the first area is high. If the number of vehicles within the second area is 2, the traffic flow determination unit 120 may determine that the density of the second area is low.

The driving route generation unit 130 generates an optimal route on which a reserved vehicle moves from a real-time location to a parking-reserved space based on the calculated density. When a reserved vehicle exits from a parking lot, the driving route generation unit 130 generates an optimal route on which a reserved vehicle moves from a real-time location to the entrance of the parking lot based on the calculated density. In this case, the optimal route is a route including a unit area whose density is determined to be relatively low among routes on which the reserved vehicle moves from the real-time location to a parking-reserved space or the entrance of the parking lot.

If the driving route generation unit 130 does not generate an optimal route, the driving route generation unit 130 may generate the shortest route. A case where the driving route generation unit 130 does not generate an optimal route is a case where a unit area whose density is determined to be low is not included by a preset ratio, among routes on which a reserved vehicle moves from a real-time location to a parking-reserved space or the entrance of a parking lot. The shortest route is the shortest route on which a reserved vehicle moves from a real-time location to a parking-reserved space or the entrance of a parking lot.

The route guidance unit 140 provides a user with an optimal route or the shortest route generated by the driving route generation unit 130. The route guidance unit 140 provides the user with a speed, a steering angle, etc. of a vehicle for moving along the generated route. The route guidance unit 140 guides a driver to a route by using a visual output and/or an auditory output.

Visual output devices include a CID (Center Infotainment Display), a cluster, RSE (Rear Seat Entertainment), a HUD (Head Up Display) and the like. CID communicates with navigation, mobile and audio systems to provide vehicle driving information and infotainment. The cluster provides information necessary for driving, such as the vehicle's driving speed, RPM, fuel amount, and collision warning. RSE is a display mainly used for entertainment activities for rear-seat occupants of a vehicle, but it also provides information about the vehicle's driving status and navigation. The HUD projects the vehicle's current speed, fuel level and navigation information as graphic images on the driver's windshield. However, the display is not limited thereto, and may include any device capable of providing visual information to a driver or passengers. The auditory output device includes an audio and sound device of a vehicle.

The charging unit 150 includes some or all of an off-route charging unit 152, a reservation violation charging unit 154, and a parking use charging unit 156.

The off-route charging unit 152 charges a user for moving off-route based on a preset charging criterion, when a reserved vehicle deviates from a route provided by the route guidance unit 140. In this case, the preset charging criterion is divided based on a degree that a reserved vehicle deviates from a provided route. The preset charging criterion may be randomly set by a settler or may be differently set based on a degree of moving off-route. For example, in the case of 9 a.m. on Monday when the parking and exiting of vehicles are frequent, it is assumed that there are many vehicles that arrive at work. In this case, if a reserved vehicle deviates from a provided route by 30% or more, a fine of 100 won per 1 m may be imposed on a user. In contrast, in the case of 2 p.m. on Wednesday, it is assumed that there are a small number of vehicles moving within a parking lot. In this case, if a reserved vehicle deviates from a provided route by 30% or more, a fine of 100 won per 3 m may be imposed on a user.

The reason why moving off-route is charged is that if some reserved vehicles deviate from their routes, density within a parking lot is changed and an optimal route needs to be generated by calculating density again for a smooth traffic flow within the parking lot.

When a reserved vehicle parks by violating reservation information, the reservation violation charging unit 154 charges a user for a violation of reservation. A case where reservation information is violated includes a case where a reserved vehicle violates a parking date and a parking lot use time, a case where a reserved vehicle parks in a parking space not a parking-reserved space, etc.

If a user has randomly changed reservation information, the reservation violation charging unit 154 charges the user for the reservation change. For example, if a user has reserved a parking space of a lower ground floor one from 6 p.m. to 8 p.m. on Dec. 1, 2021 and changes the reservation into a parking space of the lower ground floor one from 7 p.m. to 8 p.m. on the same day, the reservation violation charging unit 154 may impose a fine of 1000 won per hour.

When a reserved vehicle parks based on reservation information, the parking use charging unit 156 charges a user for parking rates based on the reservation information.

A settlement method of the off-route charging unit 152, the reservation violation charging unit 154, and the parking use charging unit 156 may be electronic payment and/or on-site payment. The electronic payment is a method of automatically paying fees that a reserved vehicle incurs for using a parking lot by using a pre-registered credit card and/or bank account. The on-site payment is a method of directly paying for, by a user, parking rates by using a parking rates settlement machine on a site, etc.

Furthermore, the off-route charging unit 152, the reservation violation charging unit 154, and the parking use charging unit 156 may change a charging criterion based on a user grade of a user. For example, a user who frequently uses a parking lot may be charged by discounting a given amount of set parking rates.

If a reserved vehicle is an autonomous vehicle, the autonomous driving unit 160 may control a speed and steering angle of the reserved vehicle so that the reserved vehicle drives based on an optimal route or the shortest route generated by the driving route generation unit. The autonomous driving unit 160 can smoothly control a traffic flow within a parking lot by controlling a reserved vehicle to drive along a generated route. A technology for performing autonomous driving includes a level 0 to a level 5 based on an autonomous driving level. As the number of the level is increased, a vehicle autonomously drives. In the level 0, a driver directly drives a vehicle. In the level 5, a system of a vehicle autonomously drives in the state in which the intervention of a driver has been completely excluded.

When a reserved vehicle completes parking in a parking-reserved space, the parking information provision unit 170 generates parking information including one or more of a map of a parking lot, a location where parking has been completed, and an entrance. The parking information provision unit 116 transmits the generated parking information to a communication terminal of a user.

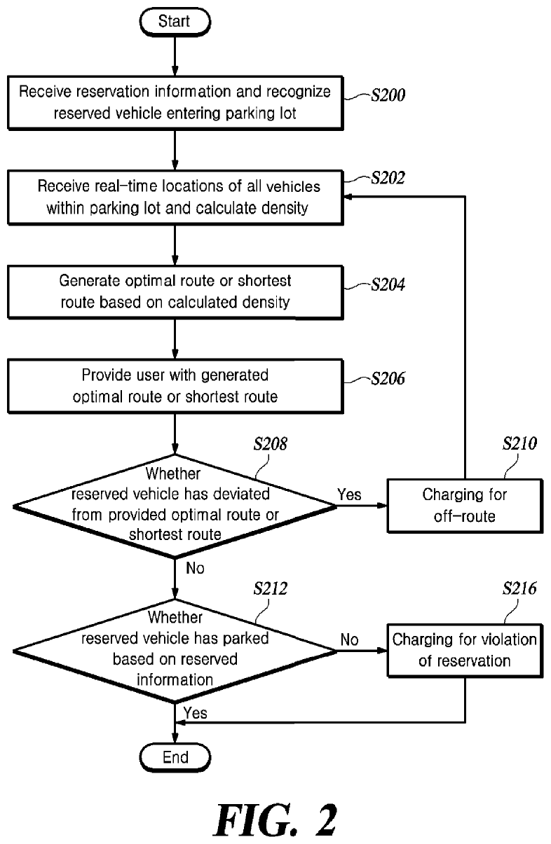

FIG. 2 is a flowchart of charging, by the apparatus for charging a parking fee according to one exemplary embodiment of the present disclosure, a reserved vehicle that parks.

Referring to FIG. 2, the reservation information communications unit 100 receives reservation information from a communication device of a parking lot and transmits the reservation information to a communication terminal of a user. The reserved vehicle recognition unit 110 recognizes a vehicle within a preset distance from the entrance of the parking lot by using a camera (S200).

The traffic flow determination unit 120 receives locations of all vehicles within the parking lot. In the case of an already parked vehicle, the traffic flow determination unit 120 receives the final location where the vehicle has already parked. The traffic flow determination unit 120 divides the area of each floor of the parking lot into given unit areas based on the received location and calculates density for each unit area (S202).

The driving route generation unit 130 generates an optimal route or the shortest route on which a reserved vehicle moves from a real-time location to a parking-reserved space based on the calculated density (S204).

The route guidance unit 140 provides the user with the generated optimal route or the shortest route (S206).

The off-route charging unit 152 determines whether the reserved vehicle deviates from a route provided by the route guidance unit 140 (S208).

If the reserved vehicle has deviated from the provided route, the off-route charging unit 152 charges the user for going off-route and returns to step S202 (S210).

If the reserved vehicle has driven along the route provided by the route guidance unit 140, the reservation violation charging unit 154 determines whether the reserved vehicle has parked in the reserved parking space (S212).

If the reserved vehicle has not parked in the parking-reserved space, the reservation violation charging unit 154 charges the user for a violation of reservation (S216).

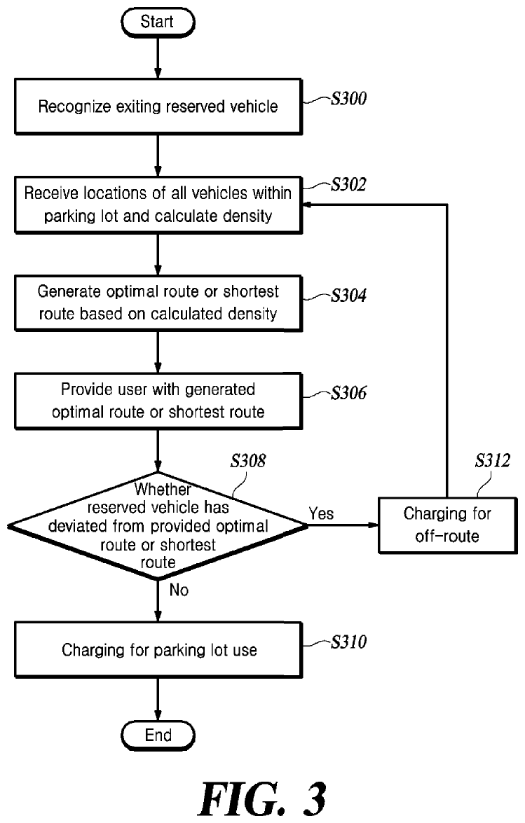

FIG. 3 is a flowchart of charging, by the apparatus for charging a parking fee according to one exemplary embodiment of the present disclosure, a reserved vehicle that exits from a parking lot.

Referring to FIG. 3, when a reserved vehicle attempts to exit from a parking lot, the reservation violation charging unit 154 recognizes the reserved vehicle (S300).

The traffic flow determination unit 120 receives locations of all vehicles within the parking lot. In the case of an already parked vehicle, the traffic flow determination unit 120 receives the final location where the vehicle has parked. The traffic flow determination unit 120 divides the area of each floor of the parking lot into given unit areas based on the received location and calculates density for each unit area (S302).

The driving route generation unit 130 generates an optimal route or the shortest route on which the reserved vehicle moves from a real-time location to the entrance of the parking lot based on the calculated density (S304).

The route guidance unit 140 provides a user with the generated optimal route or the shortest route (S306).

The off-route charging unit 152 determines whether the reserved vehicle has deviated from a route provided by the route guidance unit 140 (S308).

If the reserved vehicle drives along the provided route and the reserved vehicle recognition unit no recognizes the reserved vehicle exiting from the parking lot, the parking use charging unit 156 charges the user for the use of the parking lot (S310).

If the reserved vehicle has deviated from the provided route, the off-route charging unit 152 charges the user for moving off-route and returns to step S302. However, if the reserved vehicle has continuously deviated from the provided route and driven, when the reserved vehicle recognition unit no recognizes the reserved vehicle that exits from the parking lot, the parking use charging unit 156 charges the user for moving off-route (S312).

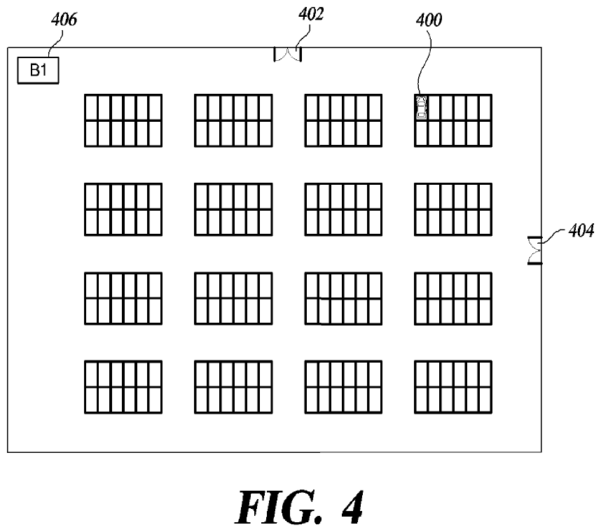

FIG. 4 is one exemplary diagram of parking information provided to a user by the apparatus for charging a parking fee according to an embodiment of the present disclosure.

Referring to FIG. 4, parking information includes one or more pieces of information including a location 400 where parking has been completed, entrances 402 and 404, and a floor 406 of a parking lot based on a map of the parking lot. The parking information is generated by the parking information provision unit 170. The parking information provision unit 170 transmits the generated parking information to a communication terminal of a user.

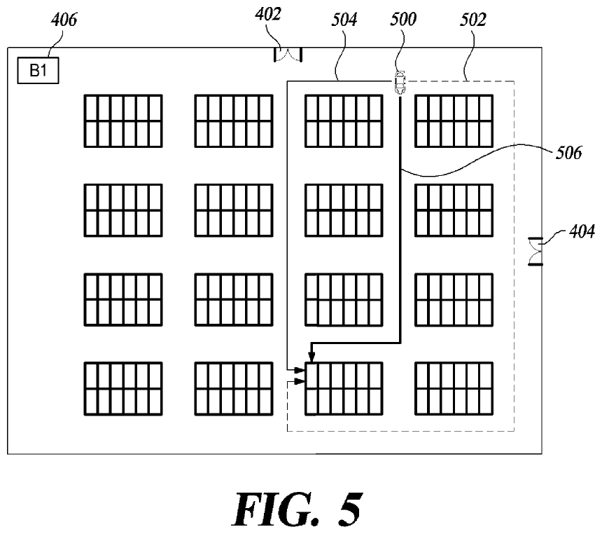

FIG. 5 is one exemplary diagram for charging a user for moving off-route when a reserved vehicle deviates from a provided route by the apparatus for charging a parking fee according to an embodiment of the present disclosure.

Referring to FIG. 5, the driving route generation unit 130 provides a user with an optimal route 502 or the shortest route 504. If a reserved vehicle 500 deviates from a provided route and drives along an arbitrary route 506, the off-route charging unit 152 charges the user for moving off-route.

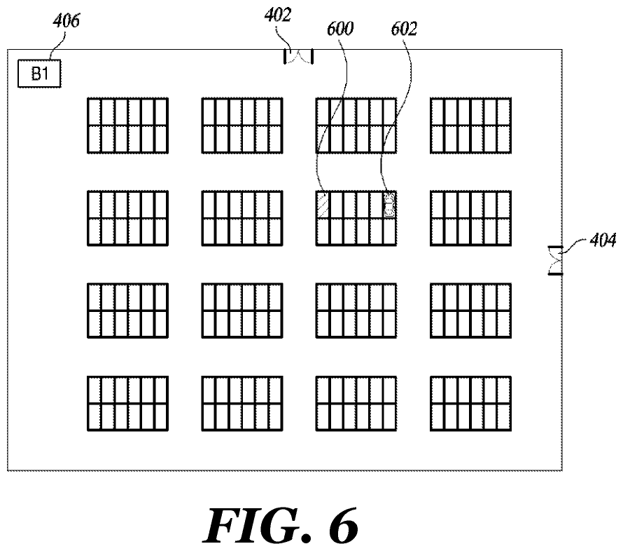

FIG. 6 is one exemplary diagram for charging a user for a violation of reservation when a reserved vehicle parks in a parking space not a parking-reserved space according to an embodiment of the present disclosure.

Referring to FIG. 6, if a parking space 600 reserved by a user is different from a parking space 602 where parking has been actually performed, the reservation violation charging unit 154 charges the user for a violation of reservation. Furthermore, even if a reserved vehicle has parked in the parking space 600 reserved by the user, if there is a violation of a use time, a reservation change, etc., the reservation violation charging unit 154 charges the user for a violation of reservation.

Although the flowcharts or timing charts of embodiments of the present disclosure present the respective steps thereof as being sequentially performed, it merely instantiates the technical idea of some embodiments of the present disclosure. Therefore, a person having ordinary skill in the pertinent art could incorporate various modifications, additions, and substitutions in practicing embodiments of the present disclosure by changing the sequence of steps illustrated by the flowcharts or timing charts or by performing one or more of the steps thereof in parallel, and hence the steps in the flowcharts or timing charts are not limited to the illustrated chronological sequences.

Various implementations of the apparatus and methods described herein may be implemented by a programmable computer. Here, the computer includes a programmable processor, a data storage system (including volatile memory, non-volatile memory, or other types of storage systems or combinations thereof) and at least one communication interface. For example, a programmable computer may be one of a server, a network appliance, a set-top box, an embedded device, a computer expansion module, a personal computer, a laptop, a Personal Data Assistant (PDA), a cloud computing system, or a mobile device.

According to one embodiment, the apparatus for charging a parking fee can provide an optimal route and/or the shortest route on which a reserved vehicle can smoothly drive to a parking-reserved space based on calculated density. Accordingly, all vehicles within a parking lot can smoothly move.

According to another embodiment, the apparatus for charging a parking fee can charge a user for moving off-route when a reserved vehicle deviates from an optimal route and/or the shortest route. Accordingly, a traffic flow within a parking lot can be made smooth because a reserved vehicle uses a provided route.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. An apparatus for charging a parking fee, the apparatus comprising:
a reservation information communications device configured to receive reservation information comprising at least one of a parking lot reserved by a user, a floor of the parking lot, a parking-reserved space, a user grade, a vehicle type, a vehicle number, a date, or a parking lot use time from a communication device of the parking lot and to transmit the reservation information to a communication terminal of the user;
a reserved vehicle recognition device configured to recognize the vehicle number of a reserved vehicle and to recognize whether the reserved vehicle enters the parking lot or exits from the parking lot by using a camera;
a traffic flow determination device configured to divide an area of each floor of the parking lot into plural areas based on a unit area, to receive locations of vehicles within the parking lot, and to calculate a density of the vehicles within the parking lot based on a number of the vehicles within each unit area;
a driving route generation device configured to generate an optimal route comprising the unit area determined to have a relatively low density among the unit areas based on the calculated density;
a route guidance device configured to provide the user with the optimal route generated by the driving route generation device; and
an off-route charging device configured to charge the user for moving off-route when the reserved vehicle does not move along the optimal route provided by the route guidance device.

2. The apparatus of claim 1, further comprising a reservation violation charging device configured to charge the user for a violation of reservation if the user performs parking or exiting by violating the reservation information.

3. The apparatus of claim 1, further comprising a parking use charging device configured to charge the user for a use of the parking lot in response to a determination by the reserved vehicle recognition device that the reserved vehicle exits the parking lot.

4. The apparatus of claim 1, wherein the reserved vehicle is an autonomous vehicle, and wherein the apparatus further comprises an autonomous driving device configured to control a speed and steering angle of the reserved vehicle so that the reserved vehicle drives along the optimal route provided by the route guidance device.

5. The apparatus of claim 1, wherein, in response to the optimal route not being generated by the driving route generation device, the driving route generation device is configured to generate a shortest route on which the reserved vehicle moves from a real-time location to the parking-reserved space or an entrance of the parking lot.

6. The apparatus of claim 1, wherein:
when the reserved vehicle recognition device does not recognize the reserved vehicle for a preset time from a scheduled time based on the reservation information, the reservation information communications device is configured to transmit a message inquiring about a reservation change to the communication terminal of the user; and
in response to receipt of changed reservation information from the communication terminal of the user by the reservation information communications device, the reserved vehicle recognition device is configured to recognize whether the reserved vehicle enters the parking lot or performs exiting from the parking lot based on the changed reservation information.

7. The apparatus of claim 6, further comprising a reservation violation charging device, wherein in response to receipt of the changed reservation information by the reservation information communications device, the reservation violation charging device is configured to charge the user for the reservation change.

8. The apparatus of claim 1, further comprising a parking information provision device configured to:
generate parking information comprising at least one of a location where the reserved vehicle has parked, an entrance of the parking lot, or the floor of the parking lot based on a map of the parking lot when the reserved vehicle has parked based on the reservation information; and
provide the parking information to the user.

9. A method of charging a parking fee, the method comprising:
receiving reservation information comprising at least one of a parking lot reserved by a user, a floor of the parking lot, a parking-reserved space, a user grade, a vehicle type, a vehicle number, a date, or a parking lot use time from a communication device of the parking lot and transmitting the reservation information to a communication terminal of the user;
recognizing the vehicle number of a reserved vehicle and recognizing whether the reserved vehicle enters the parking lot or exits from the parking lot by using a camera;
dividing an area of each floor of the parking lot into plural areas based on a unit area, receiving locations of vehicles within the parking lot, and calculating a density of the vehicles within the parking lot based on a number of the vehicles within each unit area;
generating a route comprising a unit area determined to have a relatively low density among the unit areas based on the calculated density;
providing the user with the route; and
charging the user for moving off-route if the reserved vehicle does not move along the route.

10. The method of claim 9, further comprising charging the user for a violation of reservation in response to the user performing parking or exiting by violating the reservation information.

11. The method of claim 9, further comprising charging the user for a use of the parking lot in response to a determination that the reserved vehicle exits the parking lot.

12. The method of claim 9, wherein the reserved vehicle is an autonomous vehicle, and wherein the method further comprises controlling a speed and steering angle of the reserved vehicle so that the reserved vehicle drives along the route.

13. The method of claim 9, wherein generating the route comprises generating a shortest route on which the reserved vehicle moves from a real-time location to the parking-reserved space or an entrance of the parking lot.

14. The method of claim 9, further comprising:
transmitting a message inquiring about a reservation change to the communication terminal of the user when the reserved vehicle is not recognized for a preset time from a scheduled time based on the reservation information; and
recognizing whether the reserved vehicle enters the parking lot or exits from the parking lot based on changed reservation information when the changed reservation information is received from the communication terminal of the user in response to the message inquiring about the reservation change.

15. The method of claim 14, further comprising charging the user for the reservation change.

16. The method of claim 9, further comprising:
generating parking information comprising at least one of a location where the reserved vehicle has parked, an entrance of the parking lot, or the floor of the parking lot based on a map of the parking lot when the reserved vehicle has parked based on the reservation information; and
providing the parking information to the user.

17. A method of charging a parking fee, the method comprising:
receiving reservation information comprising at least one of a parking lot reserved by a user, a floor of the parking lot, a parking-reserved space, a user grade, a vehicle type, a vehicle number, a date, or a parking lot use time from a communication device of the parking lot and transmitting the reservation information to a communication terminal of the user;
recognizing the vehicle number of a reserved vehicle and recognizing whether the reserved vehicle enters the parking lot or exits from the parking lot by using a camera;
dividing an area of each floor of the parking lot into plural areas based on a unit area, receiving locations of vehicles within the parking lot, and calculating a density of the vehicles within the parking lot based on a number of the vehicles within each unit area;
generating an optimal route comprising a unit area determined to have a relatively low density among the unit areas based on the calculated density or generating a shortest route on which the reserved vehicle moves from a real-time location to the parking-reserved space or an entrance of the parking lot;
providing the user with the optimal route or the shortest route; and
charging the user for moving off-route if the reserved vehicle does not move along the optimal route or the shortest route.

18. The method of claim 17, further comprising charging the user for a violation of reservation in response to the user performing parking or exiting by violating the reservation information.

19. The method of claim 17, further comprising charging the user for a use of the parking lot in response to a determination that the reserved vehicle exits the parking lot.

20. The method of claim 17, further comprising:
transmitting a message inquiring about a reservation change to the communication terminal of the user when the reserved vehicle is not recognized for a preset time from a scheduled time based on the reservation information;
recognizing whether the reserved vehicle enters the parking lot or exits from the parking lot based on changed reservation information when the changed reservation information is received from the communication terminal of the user in response to the message inquiring about the reservation change; and
charging the user for the reservation change.
